(19) United States
(12) Patent Application Publication
(10) Pub. No.: US 2009/0185379 A1
(43) Pub. Date: Jul. 23, 2009

(54) LED light device having heat dissipating structure

(76) Inventor: Chia-Yi Chen, Pintung Hsien (TW)

Correspondence Address: CHARLES E. BAXLEY, ESQUIRE, 90 JOHN STREET, SUITE 309, NEW YORK, NY, 10038, US

(21) Appl. No.: 12/009,923

(22) Filed: Jan. 23, 2008

(51) Int. Cl. F21V 29/00

(52) U.S. Cl. 362/294; 362/373

(57) ABSTRACT

An LED light device includes a housing having a base plate, and two side walls extended forwardly and outwardly from the base plate for forming a chamber between the side walls and the base plate, one or more light elements disposed in the chamber of the housing for generating a light, and the housing includes a number of fins extended rearwardly from the base plate for dissipating a heat generated by the light element and for preventing the LED light device from being damaged by the heat and for increasing the brightness and the working life of the LED light device.

### BACKGROUND OF THE INVENTION

1. Field of the Invention

The present invention relates to a light emitting diode (LED) light device, and more particularly to an LED light device including a heat dissipating structure for dissipating the heat generated by the LED light device and for preventing the LED light device from being damaged by the heat and for increasing the brightness and the working life of the LED light device.

2. Description of the Prior Art

Typical light devices comprise a high intensity discharge lamp for generating the light, and a cylindrical transparent sleeve disposed around the high intensity discharge lamp for shielding the high intensity discharge lamp, and two end plates healingly attached to opposing ends of the cylindrical transparent sleeve for supporting the cylindrical transparent sleeve from a ceiling structure.

For example, U.S. Pat. No. 6,247,830 to Winnett et al. discloses one of the typical heat shields for the agricultural light bulbs and also comprising a cylindrical transparent sleeve disposed around a high intensity discharge lamp for shielding the high intensity discharge lamp.

However, the heat generated by the high intensity discharge lamp may not be suitably dissipated and the accumulated heat may damage the high intensity discharge lamp.

Similarly, the other light members, such as the light bulbs, the light emitting diodes (LEDs) may also generate a great heat that will easily damage the light members. However, the typical light members also have no heat dissipating structure or devices for dissipating the heat generated by the light members.

The present invention has arisen to mitigate and/or obviate the afore-described disadvantages of the conventional LED light devices.

### SUMMARY OF THE INVENTION

The primary objective of the present invention is to provide an LED light device including a heat dissipating structure for dissipating the heat generated by the LED light device and for preventing the LED light device from being damaged by the heat and for increasing the brightness and the working life of the LED light device.

In accordance with one aspect of the invention, there is provided an LED light device comprising a housing including a base plate, and including two side walls extended forwardly and outwardly therefrom for forming a chamber between the side walls and the base plate, at least one light element disposed in the chamber of the housing for generating a light, and the housing includes a number of fins extended rearwardly from the base plate for dissipating a heat generated by the light element and for preventing the LED light device from being damaged by the heat and for increasing the brightness and the working life of the LED light device.

A circuit board is further be provided and engaged into the chamber of the housing for supporting the light element. The housing includes a channel formed in the side walls and located close to the base plate for engaging with the circuit board and for attaching the circuit board to the housing.

The light element is an LED light element. The housing includes a slot formed in a free end portion of each of the side walls. A hood is further be provided and engaged with the slots of the side walls. The hood is a curved hood.

The housing includes two brackets extended rearwardly from the base plate and each having at least one orifice formed therein for engaging with a fastener.

The housing includes at least one groove formed therein for engaging with a carrier, and the carrier includes at least one aperture formed therein for engaging with a fastener.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an LED light device in accordance with the present invention;

FIG. 2 is another perspective view of the LED light device similar to FIG. 1, in which two end caps have been removed for showing the inner structure of the LED light device;

FIG. 3 is a partial exploded view of the LED light device illustrating the operation of the LED light device;

FIG. 4 is a partial cross sectional view of the LED light device taken along lines 4-4 of FIG. 2; and

FIG. 5 is another partial exploded view of the LED light device illustrating the other arrangement of the LED light device.

### DETAILED DESCRIPTION OF THE PREFERRED EMBODIMENT

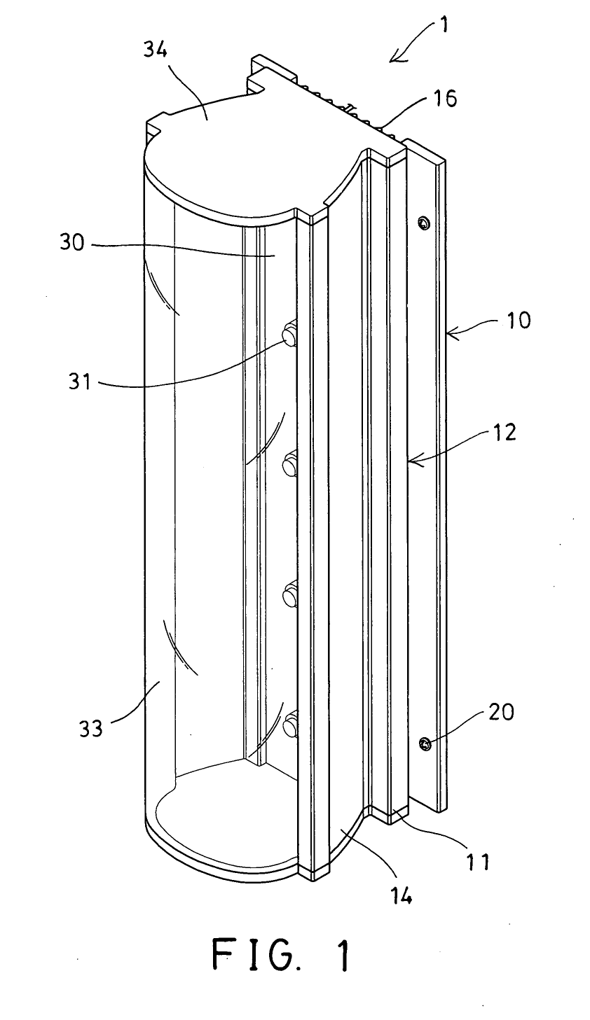

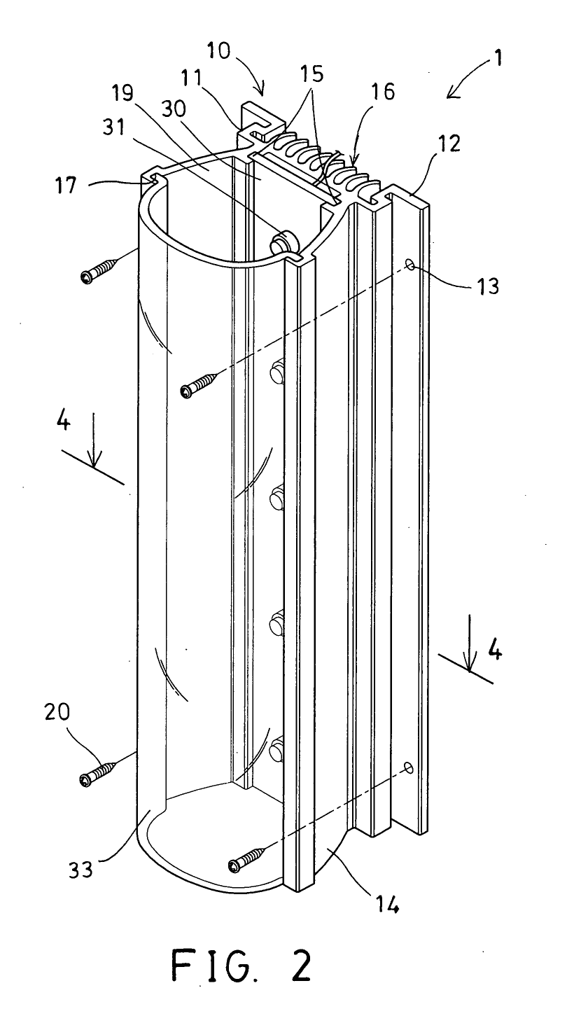

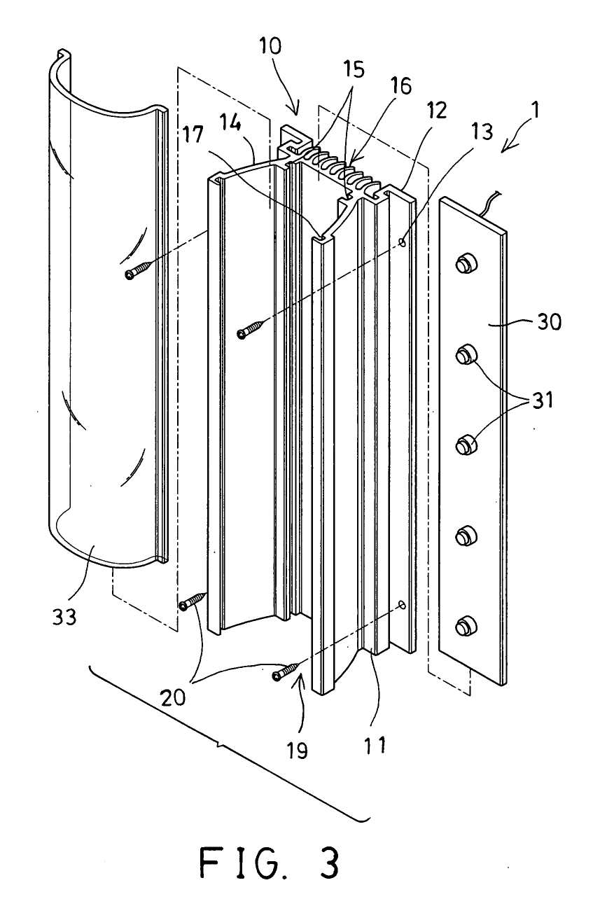

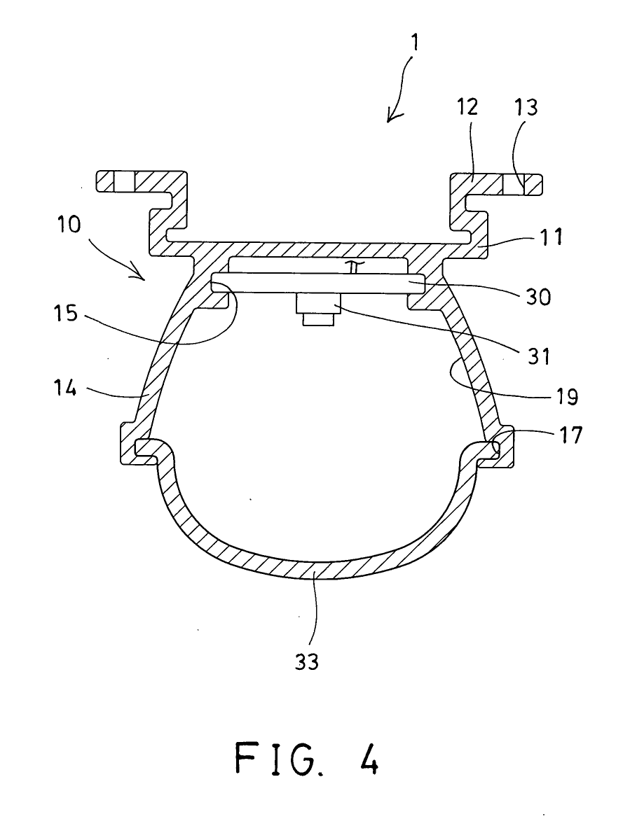

Referring to the drawings, and initially to FIGS. 1-4, an LED light device 1 in accordance with the present invention comprises a carrier or housing 10 including a base plate 11, and including one or more (such as two) brackets 12 attached to or extended from the side portions of the base plate 11 and/or extended rearwardly from the side portions of the base plate 11 and each having one or more orifices 13 formed therein for engaging with fasteners 20 which may secure the base plate 11 of the housing 10 to the ceiling structure or other supporting surfaces, and including two side walls 14 extended forwardly and outwardly therefrom and extended slightly away from each other for forming a chamber 19 between the side walls 14 and the base plate 11 and for light concentrating or condensing purposes.

The housing 10 further includes a channel 15 formed in the root portion of the side walls 14 and located close to the base plate 11 for slidably or detachably receiving or engaging with a circuit board 30, and the circuit board 30 is disposed or engaged in the chamber 19 of the housing 10 and includes one or more light elements 31, such as the high power LED light elements 31 disposed thereon and also disposed or engaged in the chamber 19 of the housing 10, and the light elements 31 may be coupled in series or parallel to each other for generating the light, in which the light generated by the light elements 31 may be suitably reflected and/or concentrated or condensed by the side walls 14 for increasing the brightness of the LED light device 1. The housing 10 further includes one or more fins 16 extended rearwardly from the base plate 11 and located between the brackets 12 for dissipating the heat generated by the light elements 31.

The housing 10 further includes a slot 17 formed in the outer or free end portion of each of the side walls 14 for slidably or detachably receiving or engaging with a transparent or semi-transparent and/or curved cover or hood 33 which may suitably cover or shield the light elements 31 for preventing the other objects or insets from entering into the housing 10, and for preventing the light elements 31 from being damaged by the other objects or insets. As shown in FIG. 1, the housing 10 may further include two end caps 34 attached to the two end portions of the housing 10 for further covering or shielding the housing 10 and for further preventing the other objects or insets from entering into the housing 10.

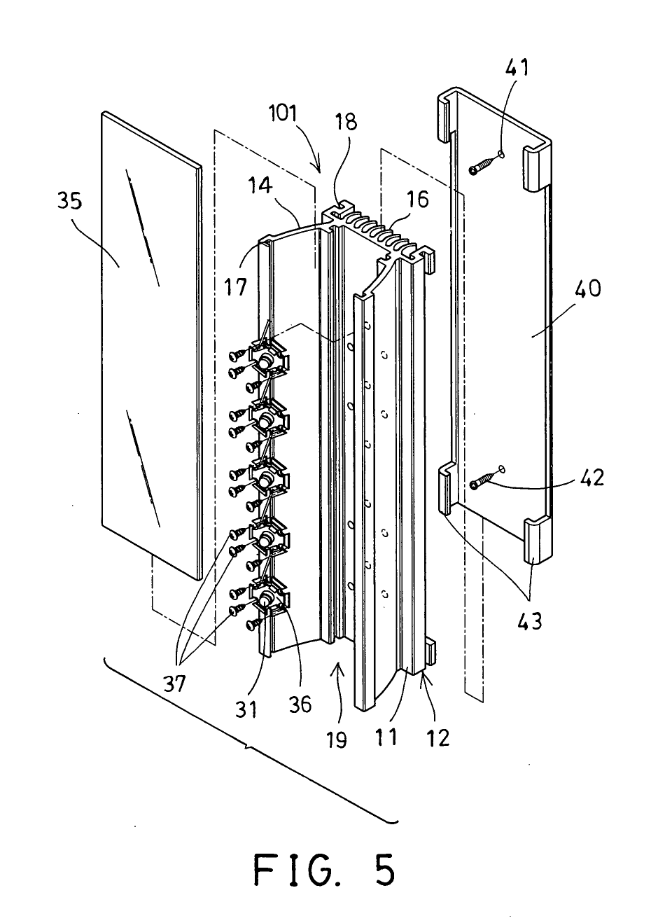

Alternatively, as shown in FIG. 5, the hood 35 may include a flat structure which is different from the curved hood 33 as that shown in FIGS. 1-4, and the circuit boards 36 may include the other shape or configuration for securing to the base plate 11 of the housing 101 with one or more fasteners 37, and the circuit boards 36 each may include one or more light elements 31 disposed thereon. The housing 101 may further include a groove 18 formed in the base plate 11 or formed in each of the brackets 12, and a carrier 40 includes one or more apertures 41 formed therein for engaging with fasteners 42 which may secure the carrier 40 to the ceiling structure or other supporting surfaces, and the carrier 40 includes one or more ears 43 extended outwardly therefrom for engaging with the grooves 18 of the brackets 12 and for readily and detachably and easily and quickly attaching the housing 101 to the carrier 40 without additional fasteners.

In operation, as shown in FIGS. 1-4, the brackets 12 of the housing 10 may be attached to the ceiling structure or other supporting surfaces directly with the fasteners 20, or indirectly with the carrier 40, the fins 16 extended rearwardly from the base plate 11 of the housing 10 may suitably dissipate the heat generated by the light elements 31 for preventing the light elements 31 or the LED light device 1 from being damaged by the heat, and thus for increasing the brightness and the working life of the light elements 31 of the LED light device 1. The side walls 14 of the housing 10 may suitably reflect and/or concentrate or condense the light for further increasing the brightness of the light elements 31 of the LED light device 1.

Accordingly, the LED light device in accordance with the present invention includes a heat dissipating structure for dissipating the heat generated by the LED light device and for preventing the LED light device from being damaged by the heat and for increasing the brightness and the working life of the LED light device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An LED light device comprising:
a housing including a base plate, and including two side walls extended forwardly and outwardly therefrom for forming a chamber between said side walls and said base plate,
at least one light element disposed in said chamber of said housing for generating a light, and
said housing including a plurality of fins extended rearwardly from said base plate for dissipating a heat generated by said at least one light element.

2. The LED light device as claimed in claim 1, wherein a circuit board is engaged into said chamber of said housing for supporting said at least one light element.

3. The LED light device as claimed in claim 2, wherein said housing includes a channel formed in said side walls and located close to said base plate for engaging with said circuit board.

4. The LED light device as claimed in claim 1, wherein said at least one light element is an LED light element.

5. The LED light device as claimed in claim 1, wherein said housing includes a slot formed in a free end portion of each of said side walls.

6. The LED light device as claimed in claim 5, wherein a hood is engaged with said slots of said side walls.

7. The LED light device as claimed in claim 6, wherein said hood is a curved hood.

8. The LED light device as claimed in claim 1, wherein said housing includes two brackets extended rearwardly from said base plate and each having at least one orifice formed therein for engaging with a fastener.

9. The LED light device as claimed in claim 1, wherein said housing includes at least one groove formed therein for engaging with a carrier, and said carrier includes at least one aperture formed therein for engaging with a fastener.
